(19) United States
(12) Patent Application Publication
(10) Pub. No.: US 2007/0280649 A1
(43) Pub. Date: Dec. 6, 2007

(54) Water supply system arranged for killing pathogens, operating device and method for killing pathogens in a water supply system

(75) Inventor: Johannes Christianus Korstanje, Al Wijk Bij Duurstede (NL)

Correspondence Address: WOOD, PHILLIPS, KATZ, CLARK & MORTIMER, 500 W. MADISON STREET, SUITE 3800, CHICAGO, IL, 60661, US

(73) Assignee: Leglofreewater Systems BV.

(21) Appl. No.: 11/807,109

(22) Filed: May 25, 2007

(30) Foreign Application Priority Data
Nov. 30, 2004 (NL) 1027625

(51) Int. Cl. H05B 3/60; F27D 11/00

(52) U.S. Cl. 392/311; 219/438; 219/385

(57) ABSTRACT

A water supply system provided with means for killing pathogens, comprising an inlet for receiving water to be provided by the system and at least one draw-off point connected to the inlet via a pipe for providing water, which means for killing pathogens comprise heating means for heating water at least to a temperature that is lethal for the pathogens, characterized in that the heating means comprise a heating element that extends within the pipe, in the longitudinal direction thereof, upstream of said at least one draw-off point.

### DESCRIPTION

The present invention relates to a water supply system provided with means for killing pathogens, comprising an inlet for receiving water to be provided by the system and at least one draw-off point for providing water which is connected to the inlet via a pipe, which means for killing pathogens comprise heating means for heating water at least to a temperature that is lethal for said pathogens.

The invention also relates to a method for killing pathogens in a water supply system comprising an inlet, one or more draw-off points and at least one pipe, said pipe extending between the inlet and the draw-off points, which method comprises the step of killing pathogens by heating water, using heating means.

Such water supply systems and methods are already known, for example water supply systems which are arranged for reducing the risk of spreading of legionella bacteria that may be present in water supply systems. Some known water supply systems are provided with a washing apparatus comprising heating means, such as a boiler or geyser installation, which washing apparatus is connected to a supply pipe. The supply pipe is periodically washed with sufficiently hot water (usually 60° C. or higher), which hot water is discharged.

A drawback of such systems is the fact that the distance between the heating means and, for example, a draw-off point of the system should not be too large, as heat exchange between the pipes of the system (which are still cold) and the washing water being introduced from the heating means causes the washing water to cool down quickly in the pipes.

A possible solution to this problem is to continue washing for a prolonged period of time, so that the pipes will become sufficiently hot, thus minimising the extent to which heat exchange takes place. A major drawback of this solution, however, is that more washing water is required. Since this washing water must also be heated, such a water supply system consumes a relatively great deal of water as well as energy for compensating the loss of energy in the pipes of the system.

Another drawback of the above solution is the fact that the temperature that is eventually achieved in the pipes is not known and that it is not possible to check said temperature or maintain it at a constant level during the washing operation. This is a major drawback, especially if such a water supply system is used in situations in which the heat exchange with the environment strongly varies, for example in the outside air, where the temperature strongly fluctuates over a period of 24 hours and in the course of a year. To be on the safe side, the heating means may be set such that a sufficiently high water temperature can still be maintained for a sufficiently long time at all locations in the system even under the most unfavourable circumstances, but those skilled in the art will appreciate that this will cause the energy and water consumption to increase even further.

Such water supply systems cannot be used in any situation, therefore. Especially when used for supplying water in places such as yacht-basins, at campsites or at events, or in the case of mobile uses, for example in (seagoing) vessels, pleasure boats, campers and/or caravans, systems such as the one described above are not suitable. That is why the number of draw-off points in yacht-basins and at campsites, for example, is often limited, which has however a negative effect as regards the ease of use of the water supply system.

It is an object of the present invention to provide a water supply system as referred to in the introduction, which obviates the drawbacks of existing water supply systems in this regard, and by means of which any pathogens (legionella, cryptosporidium, giardia, aeromonas, enterococcae, E.coli and the like) that may be present in the water provided by the water supply system can be controlled in a low-energy and safe manner.

In order to accomplish this object, the invention, in accordance with a first aspect thereof, provides a water supply system provided with means for killing pathogens, comprising an inlet for receiving water to be provided by the system and at least one draw-off point for providing water which is connected to the inlet via a pipe, which means for killing pathogens comprise heating means for heating water at least to a temperature that is lethal for said pathogens, characterized in that said heating means comprise a heating element that extends within the pipe, in the longitudinal direction thereof, upstream of said at least one draw-off point.

By installing the heating element in the pipe, in the longitudinal direction thereof, upstream of said at least one draw-off point, the water that is present in the pipe is locally heated from the inside. In this way, the energy that is supplied to the system is converted with maximum efficiency into heat for controlling pathogens at the location where this is desirable. In particular by heating the pipe from the inside by means of the heating element it is ensured that the heat being supplied is used primarily for heating the water in the pipe, whilst minimising the loss of heat to the environment. Once the water has been sufficiently heated in the pipes of such a water supply system, the system can be washed by simply drawing off the heated water.

The system according to the invention is not limited by the length of the pipes in such a system, and the system can readily be used at locations in which the ambient temperatures strongly fluctuate (e.g. in the outside air).

According to one embodiment of the invention, the heating element extends substantially from said inlet to said at least one draw-off point. This achieves that the pipe can be heated to a sufficiently high temperature along the entire length from the inlet up to and including the draw-off point, so that no untreated residual water, in which pathogens might accumulate, can remain in the system.

According to another embodiment of the system, at least one flexible pipe section is provided, and the heating element is a flexible heating element. Flexible pipe sections are frequently used in yacht-basins, for example, or for mobile applications, e.g. in caravans and/or pleasure boats, for which applications it is preferred to use a flexible heating element, since such elements can be used advantageously in the flexible pipe sections. According to one embodiment thereof, the heating element comprises at least one element of a group comprising a heating ribbon, a heating wire, a heating rod, an elongated heating spiral or spiral element, or any other suitably formed or shapable heating element.

In another embodiment of the invention, said heating element is capable of supplying sufficient power for heating the water in the pipe to a temperature of at least 60° C.

An embodiment as described above is suitable for controlling legionella bacteria in water supply systems for the purpose of reducing the risk of users of the water supply system being infected with this bacterium. It is noted in this connection that the spread of legionella bacteria in water supply systems constitutes a serious public health hazard. It is a known fact that the legionella bacterium, which causes legionellosis or legionnaire's disease, is capable of spreading quickly in water supply systems when conditions are favourable. Temperatures above 60° C. are lethal to the legionella bacterium, however, so that heating the water in the pipes of the water supply system to a temperature of at least 60° C. provides a suitable remedy against the spread of this bacterium.

According to another embodiment of the invention, a first controllable valve is provided for shutting off the pipe between the heating element and said at least one draw-off point in a controllable manner.

When the heating means are turned on, the water in the pipe will be gradually heated to the desired temperature (e.g. above 60° C.). It is preferable not to use the draw-off point in that situation, since the water being drawn off by a user of the draw-off point while the water in the pipes is being heated might be contaminated. In addition to that, a user who would expect to tap cold water from the draw-off point might get water having a temperature of 60° C. during the heating phase, with the attendant risk of injury (especially to children). Those skilled in the art will appreciate that, as an alternative to the use of said first controllable valve, the pipe could be rendered pressureless at the draw-off point.

According to another embodiment of the invention, a second controllable valve is provided for shutting off the pipe upstream of the heating element in a controllable manner. When the pipe upstream of the heating element is shut off while the pipe is being heated, it can be ensured that the heat being given off to the water in the pipe will not dissipate into water in the pipe downstream of the heating element, This leads to an efficient use of the heat in the part of the pipe where this is desirable. Furthermore this makes it possible to prevent the water elsewhere in the pipe, for example at some distance from the heating element, reaching temperatures that are in particular conducive to the proliferation of any pathogens that may be present in the water. It should be realised in this connection that water having a temperature between 30° C. and 40° C. constitutes an excellent blotope for the proliferation of, for example, legionella bacteria.

Another embodiment of the invention comprises an outlet for discharging water that has been heated by the heating element from the pipe.

The advantage of such an outlet is that the heated water need not be discharged through the draw-off point. Instead, the discharge of said water can take place separately without the user of the water supply system having access to the washing water. In this way the risk of infection and the possible risk of injury can be further reduced. Said outlet may be disposed upstream of the first controllable valve according to the embodiment of the invention as described above.

Furthermore, the outlet may comprise a pressure valve that functions to ensure that the pressure in, for example, a shut-off pipe section of the water supply system cannot run up too high or can be maintained at a constant level during said heating of the water. Think in this connection of an overflow valve, for example, via which the water that is forced from the pipe under pressure is discharged, e.g. through the sewer.

According to another embodiment, the outlet of the water supply system comprises a third controllable valve. The outlet can easily be controlled from outside by means of said valve for discharging the washing water. More in particular, a water supply system in accordance with the embodiments as described above may comprise the aforesaid first, second and third valves, so that it is possible to close the first and the second valve first for washing the water supply system, so that a closed pipe section is formed and the draw-off point cannot be provided with water, after which the heating element is activated. When the temperature is sufficiently high, and after a sufficiently long period of time, for example, the second and the third valve may be opened, so that the heated water between the first and the second valve can be discharged via the outlet under the influence of the pressure of the fresh water from the open pipe section upstream of the second valve. Once the heated water has been removed from the water supply system, the third valve can be closed and the first valve can be opened, so that fresh water is presented at the draw-off point.

According to another embodiment of the system, the water supply system comprises means for operating the first, the second or the third controllable valve as described above by remote control. It should be understood that it may be advantageous to operate the water supply system by remote control or from a central location, for example.

The signal wires for operating the first, the second or the third controllable valve according to the embodiment as described above may be integrated in or be comprised in the heating element. Those skilled in the art will appreciate that this obviates the need to install separate wiring and separate lines for the signal wires of the water supply system.

According to another embodiment, the invention comprises means for operating the heating element in a time-controlled manner. For example, if the water supply system is used in a public place, it may be desirable (or even legally required) for the water supply system to be “sanitised” at regular intervals, This requirement can readily be met by operating the heating element in the water supply system according to the invention in a time-controlled manner. For example, the owner of such a water supply system may elect to activate the heating means once every 24 hours, e.g. during the night, so that the water supply system is “sanitised” at a time when the water supply system is hardly being used, if at all.

According to another embodiment of the invention, the means for time-controlled operation of the heating element are further arranged for operating one or more of the first, second or third controllable valves in a time-controlled manner. Those skilled in the art will appreciate that a method for washing as briefly explained above can readily be carried out in a time-controlled manner, without the interference of operating staff, by using such an embodiment. This has a positive effect as regards the safety of the system, since the flushing of the system is no longer the work of man, so that the risk of human error is excluded.

According to another embodiment of the invention, means are provided for measuring the power supplied by the heating element, for example a kilowatt-hour meter. The provision of the water supply system according to the invention with such measuring means makes it possible in a simple manner to register the flushing of the system and trace any mistakes, such as defects of the heating element.

According to another embodiment of the invention, means are provided for measuring the temperature of the water being heated by the heating element. Since the temperature of the water usually needs to exceed the threshold value in order for pathogens to be killed, it is advantageous to incorporate means for measuring the temperature of the water being heated in one embodiment of the invention, since the operating staff of the water supply system can thus easily check whether the required temperature in the pipe is reached and can be maintained for a sufficiently long period of time.

According to another embodiment of the invention, the means for measuring the temperature are arranged for time-dependent measurement of the temperature, such for providing of a temperature gradient. If it is possible to record the temperature gradient of the water in the pipe either during the heating of the pipe or during normal use of the water supply system, it can be verified whether the temperature of the heated water was maintained at the desired level sufficiently long during the heating procedure, whilst in addition it can be determined whether the temperature of the water in the pipe (possibly in parts of the pipe) during normal use of the water supply system temporarily reached a level at which proliferation of pathogens in said pipe sections might have occurred during that time. If it should appear that the water in the water supply system reached “dangerous” temperature during normal use thereof, the owner of the operating staff of the water supply system may decide to activate the heating element and/or the washing system for a longer period or an additional time.

According to another embodiment of the invention, means are provided for turning off the heating element in dependence on the temperature of the water being heated by the heating element. Those skilled in the art will appreciate that if the water supply system can be set such that the heating element will be turned off automatically when a sufficiently high temperature is reached, this will be advantageous for the water supply system, since the step of heating the water in the pipe for killing the pathogens can thus be carried out in a quick and efficient manner.

According to another embodiment of the invention, means are provided for determining points in time or the frequency at which the heating element is to be activated. Such means can be advantageously used for registering or keeping records of the preventive measures that have been taken to prevent the spread of pathogens. In the Netherlands, for example, the keeping of such records for legionella prevention in tap water is a statutory requirement.

According to another embodiment of the invention, the water supply system comprises storage means for the storage of operating data. Those skilled in the art will appreciate that it may be easy if the operating parameters, such as the temperature of the water, the power supplied by the heating element, the duration and the frequency or possibly the points in time of the activation of the heating element, the duration of the flushing process and/or in the concentrations of components and/or pathogens present in the water can be stored for some time, for example in view of the aforesaid registration and/or record keeping.

According to another embodiment of the invention, an operating device for operating a water supply system as described above is provided, wherein the operating device comprises means for operating the heating element by remote control. The advantages of such an operating device have already been described above.

According to one embodiment of said operating device, the means for operating the heating element are arranged for operating the heating element in a time-controlled manner. The operating device may furthermore comprise means for operating at least one controllable valve mounted in the water supply system, such as the first, the second or the third controllable valve as described with reference to embodiments of the above-described water supply system. Said means for operating the controllable valve may be arranged for operating said valve in a time-controlled manner.

According to a second aspect of the invention, a method is provided for killing pathogens in a water supply system comprising an inlet, one or more draw-off points and at least one pipe, which pipe extends between said inlet and said draw-off points, wherein the method comprises the step of killing pathogens by heating water using heating means, characterized in that the water in the pipe upstream of at least one of said draw-off points is heated from the inside.

According to one embodiment of said second aspect of the invention, the method comprises the steps of shutting off the pipe upstream of the heating means and between the heating means and said at least one draw-off point during said heating of the water in the pipe, keeping a controllable outlet open during and after said heating of the water and opening the pipe upstream of the heating means for flushing the pipe after said heating of the water.

Said method may further comprise the step of shutting off the outlet after said flushing and opening the pipe between said at least one draw-off point and the heating means so as to make water available again at the draw-off point.

The invention will now be described on the basis of a few non-limitative embodiments thereof, which have been added for further clarification and elucidation of aspects of the invention. In the figures:

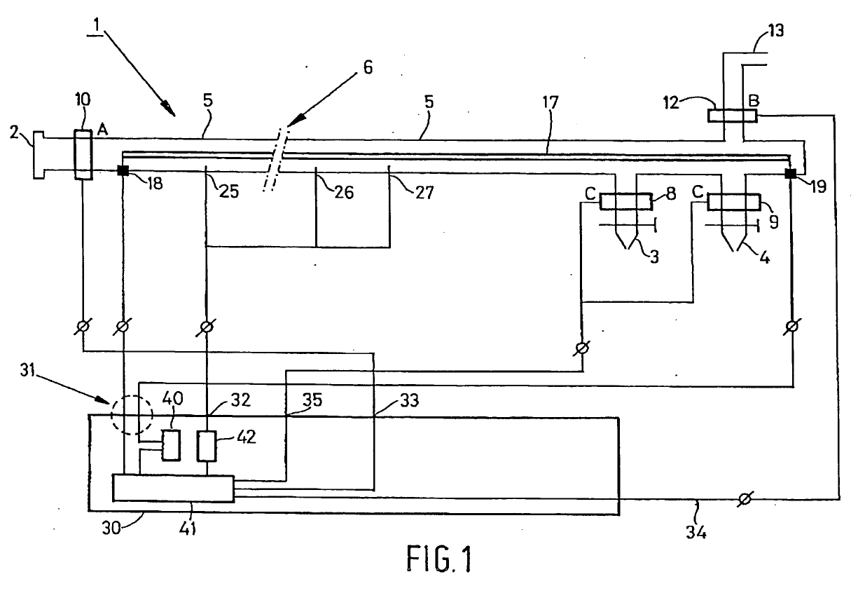

FIG. 1 shows a water supply system according to the invention, in which a heating ribbon is mounted in a pipe of the water supply system as the heating element;

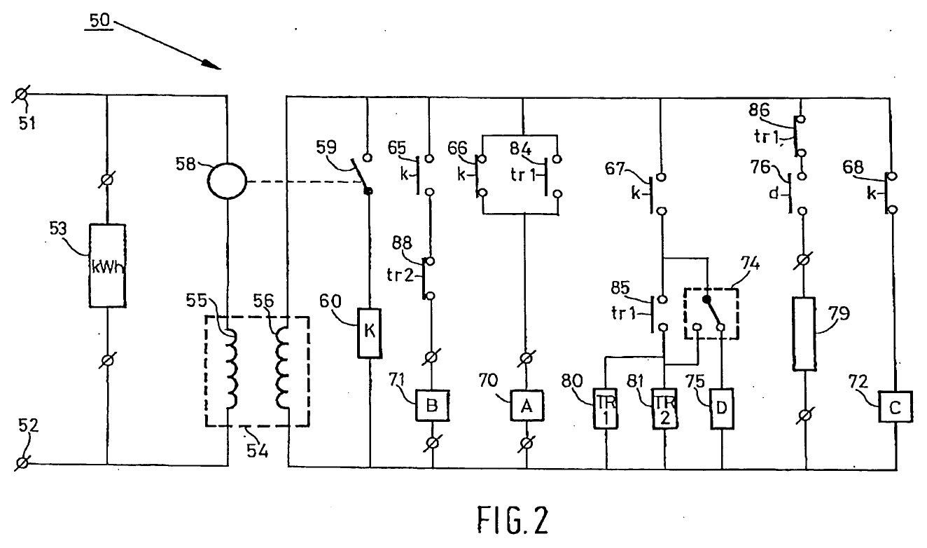

FIG. 2 is a diagram of a circuit for operating controllable valves in one embodiment according to the invention; and

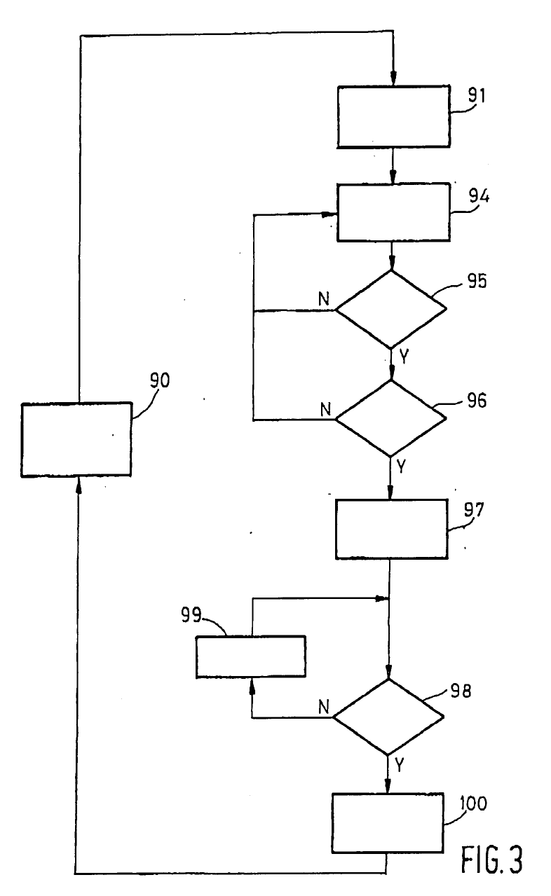

FIG. 3 shows a method according to the invention.

FIG. 1 shows a water supply system 1 according to the invention. The water supply system 1 comprises an inlet 2 and two draw-off points 3 and 4. The draw-off points 3 and 4 are connected to the inlet by means of a pipe 5. Note that the diagonal parallel lines 5 indicate that the pipe 5 may span any desired length between the inlet and the draw-off points.

In FIG. 1, the pipe 5 is a straight pipe, but those skilled in the art will appreciate that the pipe 5 may comprise any number of bends, and may even be a flexible pipe.

Two valves 8 and 9, respectively, may be disposed between the respective draw-off points 3 and 4 and their connection to the pipe 5, which valves will be referred to below as valves C (in view of their identical manner of switching). Furthermore, an outlet 13 is connected to the pipe 5, which outlet can be shut off from the pipe by means of a valve 12, which valve will be referred to below as valve B. Disposed at the beginning of the pipe 5, near the inlet 2, is a valve A, which is indicated at 10.

Present within the pipe 5 is a heating element 17, which extends substantially from valve A (10) up to at least the draw-off points 3 and 4 in the present embodiment. Those skilled in the art will appreciate that the heating element may extend a shorter distance within the pipe, if desired. Heating element 17 may preferably be a heating wire or heating ribbon of any desired type. Alternatively, heating element 17 may be a heating rod, an elongated heating spiral or spiral element, or any other suitably formed or shapable heating element. Functionally, heating element 17 should be selected such that it can be installed in pipe 5, and extends through pipe 5 over a desired length, enabling heating of the water in pipe 5 from within the pipe. Preferably, heating element 17 is capable of providing at least sufficient heat power for heating the water in pipe 5 to a temperature of at least 60 ° C., as this temperature will effectively enable control of legionella bacteria in pipe 5. Wiring for energising the heating element 17 have been installed in the pipe via lead-throughs 18 and 19: those skilled in the art will realise that the lead-throughs 18 and 19 will be watertight so as to prevent leakage of the water supply system 1. Heating element 17 may alternatively be of a double wired type, such that only a single lead-through is required for the heating element 17 in pipe 5.

Concentrically surrounding pipe 5, an isolating material such as a foam, a suitable cloth or coating, or the like may be provided to counteract heat exchange with the environment of pipe 5. This way it can be ascertained that the heat provided by heating element 17 is efficiently used for heating the water in pipe 5, enabling the use of more energy efficient heating elements for example.

Temperature measuring means or temperature sensors, such as temperature-sensitive resistors, e.g. NTC's (negative temperature coefficient resistors) 25, 26 and 27, are provided at a number of points in the pipe. The number of temperature measuring means that are used may be increased, if desired, for example in dependence on the length of the pipe 5 between the inlet 2 and the draw-off points 3 and 4.

The valves A, B and C (10, 12, 8 and 9), the heating element 17 and the NTC's 25, 29 and 27 are connected to an operating device 30. The operating device 30 may be arranged in such a manner that operating the valves A, B and C and the heating element 17, as well as reading out the NTC's 25, 28 and 27, can take place (partially) automatically, if desired, as will be described in more detail hereinafter. It is also possible to operate/read out the valves A, B and C, the heating element 17 and the NTC's 25, 26 and 27 manually, of course.

The heating element 17 is connected to inputs 31 of the operating system and, internally in the operating system, to measuring means 40 for measuring the power consumption of the heating element (e.g. in kWh). The NTC's 25, 26 and 27 are connected to the input 32 of the operating system 30, which input 32 is internally connected in the operating system to processing means 42 for converting the signals from the NTC's 25, 26 and 27 into a value that is displayed on a screen (not shown). Both the heating element 17 and the NTC's 25, 26 and 27 are furthermore connected to, for example, a time-controlled operating circuit 41 in the operating system 30. Valve A (10) is connected to an input 33 of the operating system, which is in turn connected to the time-controlled operating circuit 41 in the operating system 30. Valve B (12) is connected to an input 34 of the operating system 30, which is internally connected in the operating system 30 to the time-controlled operating system 41. Valves C (3 and 9) are connected to an input 35 of the operating system 30, which is connected to the time-controlled operating circuit 41.

In use, the operating system 30 may operate the valves A, B and C (10, 12, 8 and 9), the heating element 17 and the NTC's 25, 26 and 27 as follows. The operating system 30 may close the valve A (10) in dependence on, for example, the lapse of a predetermined period of time, e.g. by going through a time loop, whilst opening valve B (12) simultaneously therewith. Opening valve B (12) and simultaneously closing valve A (10) will not only cause the intermediate pipe section 5 to be shut off from the water supply system, but in addition said pipe 5 is rendered pressureless. Because the pipe 5 is rendered pressureless, a user of the water supply system will not be able to use the draw-off points 3 and/or 4. Said draw-off points may be shut off by means of a valve C (8 and 9) as an additional safety measure. When such a valve C (B and 9) is used, valve C must be closed simultaneously with valve A (10).

The heating element 17 can now be activated for heating the water that is present in the pipe 5. The water must be-heated in such a manner that a temperature which is lethal to any pathogens that may be present in the water (legionella, cryptosporidium, giardia, aeromonas, enterococcae, E.coli and the like) is reached for a sufficiently long period of time. For example, a temperature of at least 60° C. is required for killing legionella bacteria, the process can be shortened significantly, however, by heating the water in the pipe 5 to a higher temperature. When the desired temperature in the pipe 6 has been maintained sufficiently long, valve A is opened, so that the hot water is removed from the pipe section 5 via valve B (12) and the outlet 13 under the influence of the pressure from the water mains connected to the inlet 2. Those skilled in the art will appreciate that the heating element 17 is turned off during this stage of the method.

When washing has continued long enough, the operating system 30 will close valve B (12) and open valves C (6 and 9). As a result, the starting situation is reached, in which the draw-off points 3 and 4 can be used normally, to the effect that water having a usual temperature (e.g. cold water) will be presented at the draw-off points 3 and 4. After a predetermined period of time has elapsed, the method may be carried out again. Those skilled in the art will furthermore realise that the method as described herein may be used not only for killing pathogens, but possibly also as a frost protection system during the winter season; a temperature above 0° C. will already suffice for use as a frost protection system, however.

FIG. 2 shows a diagram of a circuit as may be used for operating a system as shown in FIG. 1. The circuit, which is generally indicated at 50, comprises two inputs 51 and 52, to which, for example, a mains voltage (220 VAC) is applied. The circuit is connected to a kilowatt-hour meter 63, which is capable of determining the amount of energy that is consumed by the system. The alternating voltage applied to the input terminals 51 and 52 is transferred to the operating part of the time-controlled circuit 50 by means of an isolation transformer. The primary coil 55 is connected to the mains voltage, and the secondary coil 56 is connected to the operating part of the time-controlled circuit. A timed relay 58, which may be connected to the mains voltage, controls a switch 59 in the operating part of the circuit. Once a predetermined period of time (e.g. 24 hours) has elapsed, the switch 59 will be closed and the relay 60 will be energised. The relay 60 controls the switches 65, 66, 67 and 68 in the time-controlled circuit 50. Energising the relay 60 causes the switch 65 to be closed, for example, so that valve B (71) is actuated. It is noted in this connection that the valves A (70), B (71) and C (72) as referred to in the description below will be open when energised, so that the water can flow through.

The switch 68 opens simultaneously with the closing of the switch 65, so that the valve A (70), which was first energised, is now de-energised, causing it to close. When the relay 60 is energised, the valves A and B are actuated simultaneously, therefore, valve B (71) being opened and valve A (70) being closed. Energising the relay 60 also causes the switch 68 to open, as a result of which valve C (72) is de-energised, causing it to close. It is noted in this connection that the switch 68 and the valve C (72) are optional.

Energising the relay 60 furthermore causes the switch 67 to close, such that the thermostat 74 is energised. The thermostat 74 is connected to measuring means (not shown) for measuring the temperature, so that the thermostat 74 can take up a position in dependence on the temperature measured in the pipe (pipe 5 in FIG. 1). In the starting position of the thermostat 74, it is switched so that the relay 75 is energised by energising the switch 67. The relay 75 drives the switch 67, so that the switch 76 will close as a result of the relay 75 being energised, causing the heating element 79 to be energised. Energising the heating element 79 will result in the water in the pipes of the water supply system (e.g. pipe 5 in FIG. 1) being heated.

Once the correct temperature has been reached (and possibly maintained sufficiently long) the thermostat 74 will change state and the timed relays 80 and 81 will be energised via the thermostat 74. The timed relay 80 will cause the switches 84 and 85 to close directly, whilst a small delay is maintained between the switching of the timed relay 81 and the subsequent switching of the timed relay 50. Closing of the switch 84 will result in the valve A (70) being energised again, so that the valve A will open. Fresh water being presented to the water supply system via the water pipe will cause the heated water in the pipe of the water supply system to be flushed out under pressure via the outlet thereof (operated by means of valve B (71)). As a result, the temperature of the water in the pipe of the water supply system will rapidly drop to the usual value, so that the thermostat 74 will change state relatively quickly again. To ensure that the timed relays 80 and 81 will not be de-energised as a result of the change of state of the thermostat, the timed relay also drives the switch 85, which temporarily bridges the thermostat 74 during the time that the timed relay 80 is energised. Another effect of the change of state of the thermostat 74 back to its previous position is that the relay 75 will be energised again, so that in principle the heating element 79 could be energised again (as a result of the corresponding closing of the switch 76). To prevent this, the timed relay 80 is also connected to the switch 86, which interrupts the voltage on the heating element temporarily during the time that the timed relay 80 is energised.

After some time, the timed relay 81 will be energised as well, in such a manner that the switch 88 is opened. Said opening of the switch 88 causes the valve B (71) to be de-energised, as a result of which it will close. The flushing process is thus terminated. The timed relay 58, which is connected to the switch 59, is now so arranged that the switch 59 is returned to its starting position after some time, in which position the switch 59 is open. In a corresponding manner, all switches 65, 68, 67 and 68 will resume their starting position, so that valve C (72) is energised, causing it to open. When the valve C is opened, the draw-of points will be provided with water again.

FIG. 3 shows the method according to the invention again. The method can be started, for example, in dependence on the system going through a time loop, which step is schematically represented at 90 in FIG. 3. In step 91 valves A and C (indicated at 10 and 8, 9, respectively, in FIG. 1 and at 70 and 72, respectively, in FIG. 2) are closed and valve B (indicated at 12 in FIG. 1 and at 71 in FIG. 2) is opened. As a result, the pipe (such as the pipe 5 in FIG. 1) is rendered pressureless. Subsequently, the heating element is energised in step 94, so that the water present in the pipe of the water supply system is heated. In step 95 it is determined whether the water is sufficiently warm, whilst in step 96 it is determined, for example, whether the temperature required for killing the pathogens has been maintained sufficiently long. It is noted in this connection that step 96 is an optional step, as those in the art will understand that the effect of step 96 can also be achieved by heating the water in the water supply system to a temperature which is amply sufficient for killing all pathogens. If either the temperature is not high enough yet or has not been maintained sufficiently long, step 94 (the heating of the water in the pipe) will be continued. However, if the correct temperature has been reached and/or maintained sufficiently long, step 97 will be carried out, and valve A will be opened, so that the water can be removed from the pipe through an outlet via the open valve B. In step 98 it is determined whether the flushing of the pipe has been continued long enough, and fresh water is present in the pipe of the water supply system and/or the usual water temperature (the temperature at which water is normally provided via the draw-of points of the water supply system) has been reached.

If this is not the case, the system will go through a waiting loop and step 98 will be carried out again. If it appears that flushing has been continued sufficiently long, however, valve B (indicated at 12 in FIG. 1 and at 71 in FIG. 2) will be closed, and valve C (indicated at 8 and 9 in FIG. 1 and at 72 in FIG. 2) will be opened. As a result, water will be provided to users in the usual manner again at the draw-off points of the water supply system.

A system as described above is not restricted to the use in a single pipe of any length, but may be implemented in a regular water supply system having a multiplicity of branches in a building, each branch having one or more draw-off points. Such a system may comprise a main supply pipe comprising a heating element extending over the (full or partial) length of the pipe. Each branch of the system comprises a further heating element. All heating elements of the system may be energised using wiring, said wiring entering the pipes of the supply system via a sufficient number of lead-throughs. Preferably, the heating elements are of a type comprising a return path, such that only a single lead-through for each element has to be provided for the wiring.

As in the embodiments described above, each of the draw-off points may be provided with a valve (such as valves C above) for shutting it during heating and washing. The system may be comprised with one or more outlets used for washing, each of said outlets being operable with a valve (such as valve B in the embodiments above). The valves of the outlets may be operable individually, such that different parts of the water supply system may be washed separately. An inlet of the water supply system, where it may be connected to a public mains water distribution network of a city, may comprise another valve (such as valve A in the embodiments above. The valves A, B and C may be operated as described hereinabove. As indicated, in case there is more than one valve B provided, the valves B may be operable individually.

The invention may be implemented for both cold water and warm water supply systems. When the invention is used for a warm water supply system, the step washing of the hot water in the pipes may be skipped. The hot water, which is clean and free of bacteria, can be provided at the draw-off point.

Taking the invention further, even a hybrid system for providing both hot and cold water can be provided using the invention. In this case, at least each hot water branch of the system should extend vertically upwards from the main pipe, and should not be washed. Heating elements in the hot water branches heat the water continuously, and since hot water has lower density than cold water, it is more buoyant such that it ascends in the vertical branch and will not mix with the cold water in the main pipe. Cold water branches are heated periodically as indicated hereinabove, and are washed after heating together with the main pipe. This enables providing clean and pathogen free hot water and cold water in a building using a single distribution system. If in the above embodiment all branches extend vertically upward from the main pipe, and all branches are provided with individually operable outlet points for washing each of the branches individually, a system is provided wherein in each branch hot or cold water can be selectably provided.

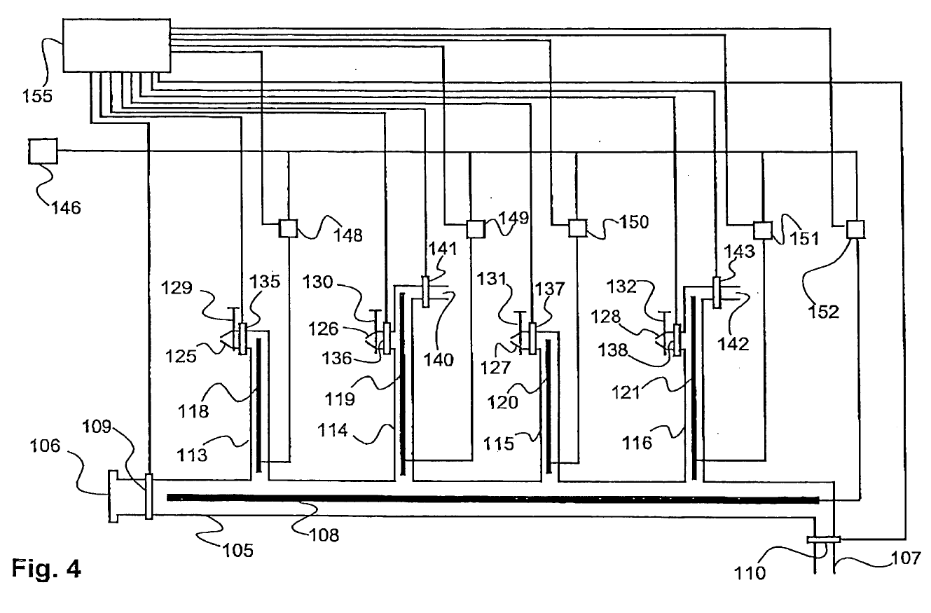

An embodiment as described above is shown in FIG. 4. Here, a main pipe 105 comprises an inlet 106 and an outlet 107. The inlet 106 may be operated using switchable valve 109, which is a type A valve corresponding to the type A valves of the embodiments disclosed in FIGS. 1 and 2. The outlet 107 can be operated through type B valve 110 (also corresponding to the valves marked B in FIGS. 1 and 2). A heating ribbon 108 having an electrical return path extends within pipe 105. Pipe 105 comprises four branches, indicated with branch pipes 113, 114, 115, and 116. Each of the branches 113-116 comprises another heating ribbon 118, 119, 120, and 121 extending within the branch pipes 113-116. At least branch 113 and 115 extend in an upward direction from the main pipe 105 (in the present embodiment, all branches 113-116 extend vertically upward), as these branches will be used as hot water branches. It is noted that the hot water branches not necessarily extend vertically upward; as long as these branches extend in an upward direction buoyancy in these branches will cause hot water to be kept separated from cold water in the (cold water) main pipe 105.

Each branch also comprises at least one draw-off point 125, 126, 127, 126. The draw-off point can be user operated with manual valves 129, 130, 131, and 132. Each draw-off point can be closed using a C-type valve 135, 136, 137 and 138 (corresponding to the valves marked C in FIGS. 1 and 2). The C-type valves 135-138 are operable using control unit 155, to which each of the valves 135-138 is connected. Preferably, the valves 135-138 can be controlled individually from each other.

Each of the heating ribbons 118, 119, 120, 121 and 108 in the main pipe 105 and each of the branch pipes 113, 114, 115 and 116, can be energised individually. The heating ribbons 108 and 118-121 are thereto connected to a power supply 146, and power to each heating ribbon is controllable using switch boxes 148, 149, 150, 151, and 152 respectively. The switch boxes are connected with signal wires to control unit 155.

The branches 114 and 116 can be used as cold water branches, and both comprise an outlet 140 and 142, operable through B-type valves 141 and 143. Hot water branches 113 and 115 do not require an outlet in the present embodiment, since the heating ribbons 118 and 120 are operated such that the water in the branches 113 and 115 is always kept at a sufficiently high temperature for killing pathogens (preferably >60° C.) but within a usual temperature range for providing hot consumption water. Therefore, the water in these branches 113 and 115 is free of pathogens and can be readily used for hot water consumption (e.g. shower, sink, etc.).

The main pipe 105 and the cold water branches 114 and 116 periodically heated by energizing heating ribbons 108, 119 and 121. After heating, these pipes 105, 114 and 116 are washed by opening B-type valves 141 and 143 and A-type valve 109. At least C-type valves 138 and 138 are kept closed during heating and washing of (cold water) pipes 105, 114 and 116. Optionally, C-type valves 135 and 137 may be kept closed as wall during this period.

Not only a water supply system for providing water for consumption can be provided using the invention, the invention may also be installed in a water supply system connected to a fire extinguishing system. In such systems, water often remains for a long time until the system is tested or used in practice. Bacteria may accumulate under these conditions, such that in a case of fire, the bacteria may spread easily. This problem can be overcome using the method and system of the present invention.

Those skilled in the art will appreciate that the embodiments as shown in the figures are solely intended to illustrate of the invention. The embodiments relate to an automatic operating system, but all the steps described in the method may be carried out manually, if desired. In that case a much simpler switching system will suffice. This embodiment has not been further elaborated in the present description. The scope of the invention as described herein is limited only by the appended claims. It will be understood that the embodiments as shown and described herein must not be construed as limitative, therefore.

With regard to the method and the system as disclosed herein it should furthermore be noted that such a system can readily be adapted for protecting the pipes of a water distribution system against frost during periods of frost, A thermostat may be added to the system, for example, which causes the heating means to be turned on, for example for a short period of time, as soon as the temperature of the water present in the pipe falls below a threshold value (for example 10° C.).

1. A water supply system provided with means for killing pathogens, comprising an inlet for receiving water to be provided by the system and at least one draw-off point for providing water which is connected to the inlet via a pipe for providing water, which means for killing pathogens comprise heating means for heating water at least to a temperature that is lethal for said pathogens, characterized in that said heating means comprise a heating element that extends within the pipe, in the longitudinal direction thereof, upstream of said at least one draw-off point.

2. A water supply system according to claim 1, wherein the heating element extends substantially from said inlet to said at least one draw-off point.

3. A water supply system according to claim 1, wherein the pipe comprises at least one flexible pipe section, and wherein the heating element is a flexible heating element.

4. A water supply system according to claim 3, wherein said heating element comprises at least one element of a group comprising a heating ribbon, a heating wire, a heating rod, an elongated heating spiral or spiral element, or any other suitably formed or shapable heating element.

5. A water supply system according to claim 4, wherein said heating element is capable of supplying sufficient power for heating the water in the pipe to a temperature of at least 60° C.

6. A water supply system according to claim 1, further comprising a first controllable valve for shutting off the pipe between the heating element and said at least one draw-off point in a controllable manner.

7. A water supply system according to claim 6, further comprising a second controllable valve for shutting off the pipe upstream of the heating element in a controllable manner.

8. A water supply system according to claim 1, further comprising an outlet for discharging water that has been heated by the heating element from the pipe.

9. A water supply system according to claim 8, wherein said outlet is disposed upstream of said first controllable valve.

10. A water supply system according to claim 8, wherein said outlet comprises a pressure valve.

11. A water supply system according to claim 7, wherein said outlet comprises a third controllable valve.

12. A water supply system according to claim 11, further comprising means for operating one or more of said first, said second or said third controllable valve by remote control.

13. A water supply system according to claim 12, wherein the heating element comprises signal wires for operating the first, the second or the third controllable valve.

14. A water supply system according to claim 1, further comprising means for operating the heating element in a time-controlled manner.

15. A water supply system according to claim 11, wherein said means for time-controlled operation of the heating element are further arranged for operating one or more of the first, second or third controllable valves in a time-controlled manner,

16. A water supply system according to claim 1, further comprising means for measuring the power supplied by the heating element, for example a kilowatt-hour meter.

17. A water supply system according to claim 1, further comprising means for measuring the temperature of the water being heated by the heating element.

18. A water supply system according to claim 17, wherein the means for measuring the temperature are arranged for time-dependent measurement of the temperature, such as for providing of a temperature gradient.

19. A water supply system according to claim 17, further comprising means for turning off the heating element in dependence on the temperature of the water being heated by the heating element.

20. A water supply system according to claim 1, further comprising means for determining points in time or the frequency at which the heating element is to be activated.

21. A water supply system according to claim 19, further comprising storage means for the storage of operating data.

22. A water supply system according to claim 1 comprising a main pipe and one or more branch pipes, said main pipe comprising said inlet for receiving said water to be provided by said system, and said one or more branch pipe comprising one or more draw-off points, wherein said main pipe and each of said branch pipes comprises a heating element, wherein at least one branch pipe of said one or more branch pipes extends for at least a part thereof vertically upwards from said main pipe, and wherein at least said heating element in said at least one branch pipe extending vertically upwards from said main pipe can be energised individually from said other of said heating elements.

23. An operating device for operating a water supply system according to claim 1, comprising means for operating the heating element by remote control.

24. An operating device according to claim 23, wherein the means for operating the heating element are arranged for operating the heating element in a time controlled manner.

25. An operating device according to claim 23, further comprising means for operating at least one controllable valve mounted in the water supply system.

26. An operating device according to claim 25, wherein said means for operating said at least one controllable valve are arranged for operating said valve in a time-controlled manner.

27. A method for killing pathogens in a water supply system comprising an inlet, one or more draw-off points and at least one pipe, which pipe extends between said inlet and said draw-off points, wherein the method comprises the step of killing pathogens by heating water using heating means, characterized in that the water in the pipe upstream of at least one of said draw-off points is heated from the inside.

28. A method according to claim 27, further comprising the step of shutting off the pipe between said at least one draw-off point and said heating means during said heating of the water.

29. A method according to claim 27, further comprising the step of shutting off the pipe upstream of the heating means during said heating of the water

30. A method according to claim 27, further comprising the step of washing the pipe after said heating of the water.

31. A method according to claim 30, further comprising the step of discharging of the water from the pipe via an outlet during said washing.

32. A method according to claim 30, wherein the method comprises the steps of shutting off the pipe upstream of the heating means and between the heating means and said at least one draw-off point during said heating of the water in the pipe, keeping a controllable outlet open during and after said heating of the water and opening the pipe upstream of the heating means for washing the pipe after said heating of the water.

33. A method according to claim 32, further comprising a step of shutting off the outlet after said washing and opening the pipe between said at least one draw-off point and the heating means so as to make water available at the draw-off point.

34. A method according to claim 27, further comprising a step of measuring the temperature of the water being heated in the pipe during the heating step.

35. A method according to claim 34, wherein said heating stop is stopped when the temperature of the water in the pipe is sufficiently high for killing said pathogens.
